(19) United States
(12) Patent Application Publication
(10) Pub. No.: US 2023/0400602 A1
(43) Pub. Date: Dec. 14, 2023

(54) METHOD AND SYSTEM FOR MODELING OIL/WATER OR GAS/WATER PALEO ZONE RESERVOIR PROPERTIES FOR HYDROCARBON MANAGEMENT

(71) Applicant: ExxonMobil Technology and Engineering Company, Spring, TX (US)

(72) Inventors: Jizhou LI, The Woodlands, TX (US); Pengbo LU, Houston, TX (US); Boqian SHEN, Ann Arbor, MI (US)

(21) Appl. No.: 18/334,568

(22) Filed: Jun. 14, 2023

Related U.S. Application Data
(60) Provisional application No. 63/366,351, filed on Jun. 14, 2022.

(51) Int. Cl. G01V 99/00

(52) U.S. Cl. CPC G01V 99/005

(57) ABSTRACT

A methodology for modeling oil/water or gas/water paleo zone reservoir properties for hydrocarbon management is provided. Reservoir simulations in a subsurface, such as in an oil region bounded by a gas cap and a water region, may use an initial reservoir simulation model. The methodology determines one or both of the oil/water or gas/water interfaces to honor the equilibrium state of the subsurface. The current configuration of the subsurface may be the result of one or more processes, such as a drainage process and an imbibition process, each of which have different associated curves reflecting the physical phenomena of the fluid/rock properties in the subsurface. The methodology honors the physical process, including comporting with the different curves and with the available data, in order to determine the current state of the subsurface, including one or both of the oil/water or gas/water interfaces.

### CROSS-REFERENCE TO RELATED APPLICATION

This application claims the benefit of U.S. Provisional Application Ser. No. 63/366,351, entitled “Method and System for Modeling Oil/Water or Gas/Water Paleo Zone Reservoir Properties for Hydrocarbon Management,” filed Jun. 14, 2022, the disclosure of which is hereby incorporated by reference in its entirety.

### FIELD OF THE INVENTION

The present application relates generally to the field of hydrocarbon exploration, development and production. Specifically, the disclosure relates to a methodology for modeling oil/water or gas/water interfaces for hydrocarbon management.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

In many large oil or gas fields, well logs indicate a retaining trapped oil or gas zone below the main pay zone and the current free water level, which is referred to as the paleo zone. The formation of the paleo zone is often understood to be caused by structural tectonic events with subsequent water influx which could also form tilted water-hydrocarbon contact. See Ahmed Aleidan et al., Residual-Oil Zone: Paleo-Oil Characterization and Fundamental Analysis, SPE Reservoir Evaluation & Engineering, 02: Vol. 20 (2016); see also Mohamed Mehdi El Faidouzi et al., Physics-Based Initialization Captures Post-Migration Structural Deformation in Mixed-Wet Carbonates: An Integrated Workflow for Tilted Oil-Water Contact Reservoirs, Abu Dhabi International Petroleum Exhibition and Conference.—Abu Dhabi: SPE, 2020.—Vols. Day 2 Tue, Nov. 10, 2020.

A reliable estimate of paleo zone fluids and pressure distribution may assist in hydrocarbon extraction, such as by capturing the correct physics (e.g., the paleo zone baffling effect and displacement hysteresis for history matching in conventional reservoirs), and by properly estimating the potential of an enhance oil recovery (EOR) process to mobilize the trapped residual oil. See Arne Skauge et al., Gas Injection in Paleo Oil Zones, SPE Annual Technical Conference and Exhibition, Dallas, Texas (2000). For example, for giant gas reservoir developments, obtaining a reasonable estimate of recoverable resource in place and the risk of potential water production volume are central to major LNG projects' contract negotiation and partner alignment. See Ian Taggart, Characterisation and Simulation Insights for Gas Reservoirs with Paleo-Contact, SPE Europec featured at EAGE Conference and Exhibition, SPE, 2019.—Vols. Day 2, Jun. 4, 2019.

### SUMMARY OF THE INVENTION

In one or some embodiments, a computer-implemented method of determining and using current steady-state pressure distribution in a subsurface is disclosed. The method includes: determining paleo phase pressure distribution for at least a part of the subsurface; accessing current phase pressures for the at least a part of the subsurface; determining, by iteratively determining hysteresis scanning curves using the paleo phase pressure distribution and the current phase pressures, the current steady-state pressure distribution in the at least a part of the subsurface; and using the current steady-state pressure distribution for hydrocarbon management.

In one or some embodiments, a computer-implemented method to generate a subsurface initialization model for a subsurface is disclosed. The method includes: accessing a current free water level (FWL) indicative of a contact surface between oil and water in the subsurface; accessing a paleo FWL; determining a current steady-state oil/water interface and a current steady-state gas/water interface in the subsurface; performing, using the current steady-state oil/water interface and the current steady-state gas/water interface, a subsurface reservoir simulation to generate one or more results; and using the one or more results for hydrocarbon management.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1A is a representation of gas/oil and oil/water interfaces in a subsurface.

FIG. 1B is a representation of movement of the paleo-contact in the subsurface.

FIG. 1C is a graph of water saturation (Sw) versus capillary pressure (Pc) showing the path along a first curve as part of the drainage process corresponding to the movement of the paleo-contact depicted in FIG. 1B.

FIG. 1D is a representation of the movement of the various interfaces, including from the paleo free water level (FWL) to the current FWL.

FIG. 1E is a graph of water saturation (Sw) versus capillary pressure (Pc) showing the path along a second curve as part of the imbibition process corresponding to the movement from the paleo free water level (FWL) to the current FWL depicted in FIG. 1D.

FIGS. 2A-C are a series of images from paleo contact (FIG. 2A) to structure tilting (FIG. 2B) to current contact (FIG. 2C), whereby the structure tilting results in water migration inducing fluid rebalancing which may result in trapped oil below the current FWL (as depicted in FIG. 2C).

FIG. 3A is a graph of pressure versus depth with curves for the current water pressure (Pw), current oil pressure (Po) and Paleo water pressure (Pw Paleo).

FIG. 3B is the graph depicted in FIG. 3A with highlighted distance between the different curves as a difference in pressure.

FIG. 3C is a graph of the water saturation (Sw) versus capillary pressure (Pc) with the difference in pressure from FIG. 3B illustrated.

FIG. 3D is the graph depicted in FIG. 3A with additional highlighted distances between the different curves as additional differences in pressure.

FIG. 3E is a graph of the water saturation (Sw) versus capillary pressure (Pc) illustrated in FIG. 3C with the additional differences in pressure from FIG. 3D illustrated.

FIG. 3F is a graph of water saturation (Sw) versus relative permeability (Know).

FIG. 3G is a graph of water saturation (Sw) versus depth with points highlighted from FIGS. 3D-F.

FIG. 4 is a flow chart for determining the pressure distribution, such as by using parallel computational architectures for each vertical column of grid-blocks of reservoir model.

FIG. 5A is an image illustrating an initialization of the water front movement using a typical methodology.

FIG. 5B is an image illustrating an initialization of the water front movement using the disclosed methodology, with more stable waterfront movement shown in FIG. 5B versus 5A.

FIG. 6 is a graph of water saturation (Sw) versus depth for simulation results (e.g., g5 simulation) and for initialization using the disclosed methodology.

FIG. 7 is a diagram of an exemplary computer system that may be utilized to implement the methods described herein.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

The term “seismic data” as used herein broadly means any data received and/or recorded as part of the seismic surveying and interpretation process, including displacement, velocity and/or acceleration, pressure and/or rotation, wave reflection, and/or refraction data. “Seismic data” is also intended to include any data (e.g., seismic image, migration image, reverse-time migration image, pre-stack image, partially-stack image, full-stack image, post-stack image or seismic attribute image) or interpretation quantities, including geophysical properties such as one or more of: elastic properties (e.g., P and/or S wave velocity, P-Impedance, S-Impedance, density, attenuation, anisotropy and the like); and porosity, permeability or the like, that the ordinarily skilled artisan at the time of this disclosure will recognize may be inferred or otherwise derived from such data received and/or recorded as part of the seismic surveying and interpretation process. Thus, this disclosure may at times refer to “seismic data and/or data derived therefrom,” or equivalently simply to “seismic data.” Both terms are intended to include both measured/recorded seismic data and such derived data, unless the context clearly indicates that only one or the other is intended. “Seismic data” may also include data derived from traditional seismic (e.g., acoustic) data sets in conjunction with other geophysical data, including, for example, gravity plus seismic; gravity plus electromagnetic plus seismic data, etc. For example, joint-inversion utilizes multiple geophysical data types.

The term “geophysical data” as used herein broadly includes seismic data, as well as other data obtained from non-seismic geophysical methods such as electrical resistivity. In this regard, examples of geophysical data include, but are not limited to, seismic data, gravity surveys, magnetic data, electromagnetic data, well logs, image logs, radar data, or temperature data.

The term “geological features” (interchangeably termed geo-features) as used herein broadly includes attributes associated with a subsurface, such as any one, any combination, or all of: subsurface geological structures (e.g., channels, volcanos, salt bodies, geological bodies, geological layers, etc.); boundaries between subsurface geological structures (e.g., a boundary between geological layers or formations, etc.); or structure details about a subsurface formation (e.g., subsurface horizons, subsurface faults, mineral deposits, bright spots, salt welds, distributions or proportions of geological features (e.g., lithotype proportions, facies relationships, distribution of petrophysical properties within a defined depositional facies), etc.). In this regard, geological features may include one or more subsurface features, such as subsurface fluid features, which may be hydrocarbon indicators (e.g., Direct Hydrocarbon Indicator (DHI)).

The terms “velocity model,” “density model,” “physical property model,” or other similar terms as used herein refer to a numerical representation of parameters for subsurface regions. Generally, the numerical representation includes an array of numbers, typically a 2-D or 3-D array, where each number, which may be called a “model parameter,” is a value of velocity, density, or another physical property in a cell, where a subsurface region has been conceptually divided into discrete cells for computational purposes. For example, the spatial distribution of velocity may be modeled using constant-velocity units (layers) through which ray paths obeying Snell's law can be traced. A 3-D geologic model (particularly a model represented in image form) may be represented in volume elements (voxels), in a similar way that a photograph (or 2-D geologic model) may be represented by picture elements (pixels). Such numerical representations may be shape-based or functional forms in addition to, or in lieu of, cell-based numerical representations.

The term “subsurface model” as used herein refer to a numerical, spatial representation of a specified region or properties in the subsurface.

The term “geologic model” as used herein refer to a subsurface model that is aligned with specified geological feature such as faults and specified horizons.

The term “reservoir model” as used herein refer to a geologic model where a plurality of locations have assigned properties including any one, any combination, or all of rock type, EoD, subtypes of EoD (sub-EoD), porosity, clay volume, permeability, fluid saturations, etc.

For the purpose of the present disclosure, subsurface model, geologic model, and reservoir model are used interchangeably unless denoted otherwise.

As used herein, “hydrocarbon management”, “managing hydrocarbons” or “hydrocarbon resource management” includes any one, any combination, or all of the following: hydrocarbon extraction; hydrocarbon production (e.g., drilling a well and prospecting for, and/or producing, hydrocarbons using the well; and/or, causing a well to be drilled, e.g., to prospect for hydrocarbons); hydrocarbon exploration; identifying potential hydrocarbon-bearing formations; characterizing hydrocarbon-bearing formations; identifying well locations; determining well injection rates; determining well extraction rates; identifying reservoir connectivity; acquiring, disposing of, and/or abandoning hydrocarbon resources; reviewing prior hydrocarbon management decisions; and any other hydrocarbon-related acts or activities, such activities typically taking place with respect to a subsurface formation. The aforementioned broadly include not only the acts themselves (e.g., extraction, production, drilling a well, etc.), but also or instead the direction and/or causation of such acts (e.g., causing hydrocarbons to be extracted, causing hydrocarbons to be produced, causing a well to be drilled, causing the prospecting of hydrocarbons, etc.). Hydrocarbon management may include reservoir surveillance and/or geophysical optimization. For example, reservoir surveillance data may include, well production rates (how much water, oil, or gas is extracted over time), well injection rates (how much water or CO₂ is injected over time), well pressure history, and time-lapse geophysical data. As another example, geophysical optimization may include a variety of methods geared to find an optimum model (and/or a series of models which orbit the optimum model) that is consistent with observed/measured geophysical data and geologic experience, process, and/or observation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

Reservoir simulations may assist in hydrocarbon development. See US Patent Application Publication No. 2020/0302293 A1, incorporated by reference in its entirety. Merely by way of example, one goal of reservoir simulation is to mimic field development operations in the simulation to determine the output of the field in the simulation environment prior to actually developing the field. Decisions made in the simulation may include where to place wells, and once the wells are placed, flow rates for each of the wells (e.g., injection rates to maintain pressure in the reservoir for injection wells, flow rates to maximize output for production wells, etc.).

One example reservoir for simulation comprises a subsurface with an oil region bounded by a gas cap and a water region (e.g., aquifer). Typically, the reservoir simulation is initialized using an initial reservoir simulation model. One way to generate the initial reservoir simulation model is to perform an initial simulation; however, such a method may be computationally expensive and may not necessarily honor the physical constraints in a subsurface or may not comport with the data obtained. Thus, in one or some embodiments, a methodology is disclosed that generates an initial reservoir simulation model that honors the physics which generated the reservoir subject to analysis.

As discussed in more detail below, the subsurface may currently include an oil zone in between a gas cap and water aquifer. However, the current configuration in the subsurface is based on one or more previous processes, such as a drainage process and an imbibition process. In particular, the drainage process, in which oil pushes water in the subsurface, results in the initial paleo contact. After which, various geological events, such as leakage in which water in effect pushes the oil during the imbibition process, results in the current steady-state formation of the oil zone, the gas cap and the aquifer.

The physics associated with the drainage process and the imbibition process are different and correspond to different curves. In this regard, the curves are subject to hysteresis and reflect the physical phenomenon of the fluid/rock properties in the subsurface. By way of example, different forms of hysteresis, including capillary hysteresis and relative permeability hysteresis, are examined dependent on the different stages (e.g., during reservoir charging in which the reservoir is being formed and during subsequent stages). As such, the disclosed methodology seeks to honor the physical process (including comporting with the different curves) and to comport with the available data. In this regard, the process may access measurements (e.g., oil pressure at reference depth(s)), which may be used to determine oil pressure (Po). In turn, the methodology determines the various interfaces (e.g., one or both of the oil/water or gas/water interfaces) of the subsurface in its current state that comports with the various measurements and further comports with the physics of the different stages. For example, the methodology may iteratively adjust the scanning curves to better match the measurements while matching the physics of creation of the reservoir. In this regard, the methodology comprises a paleo zone modeling technology to generate both gas/water and oil/water interfaces utilizing hysteresis, unlike previous methodologies. In one or some embodiments, the methodology may utilize high-performance computing (HPC) to iteratively determine the gas/water and oil/water interfaces.

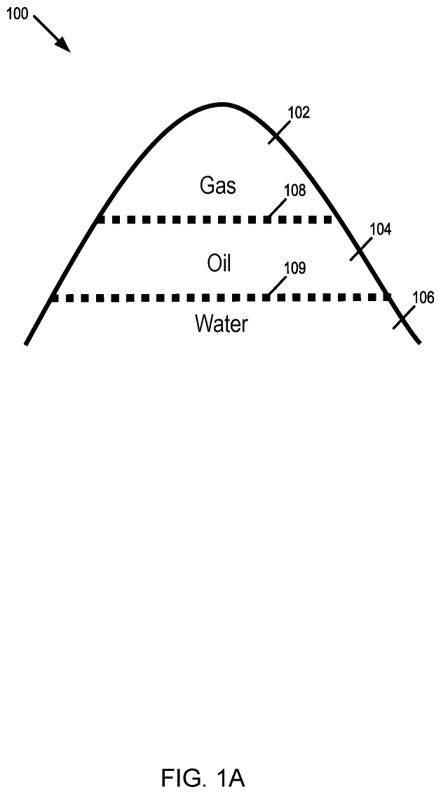

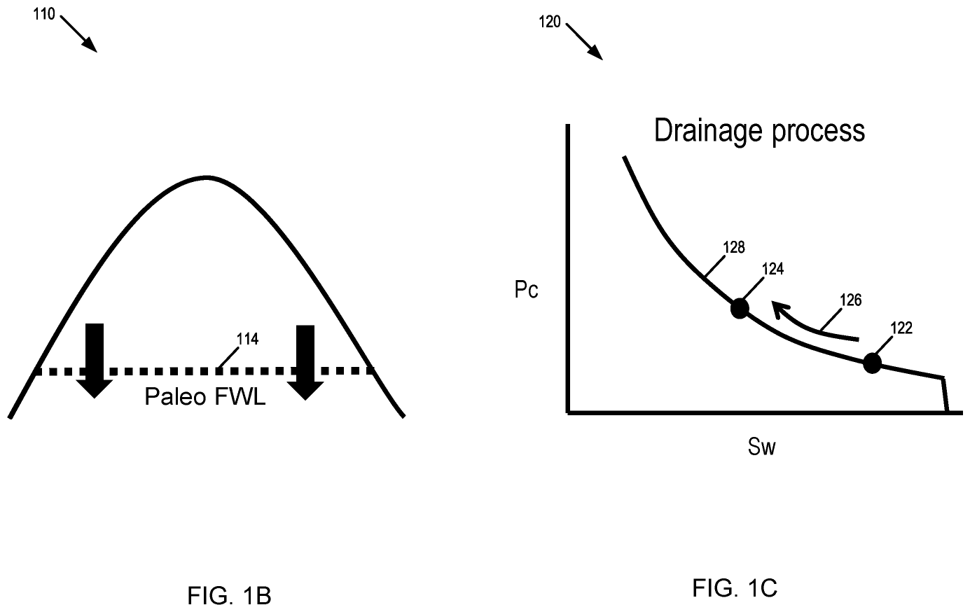

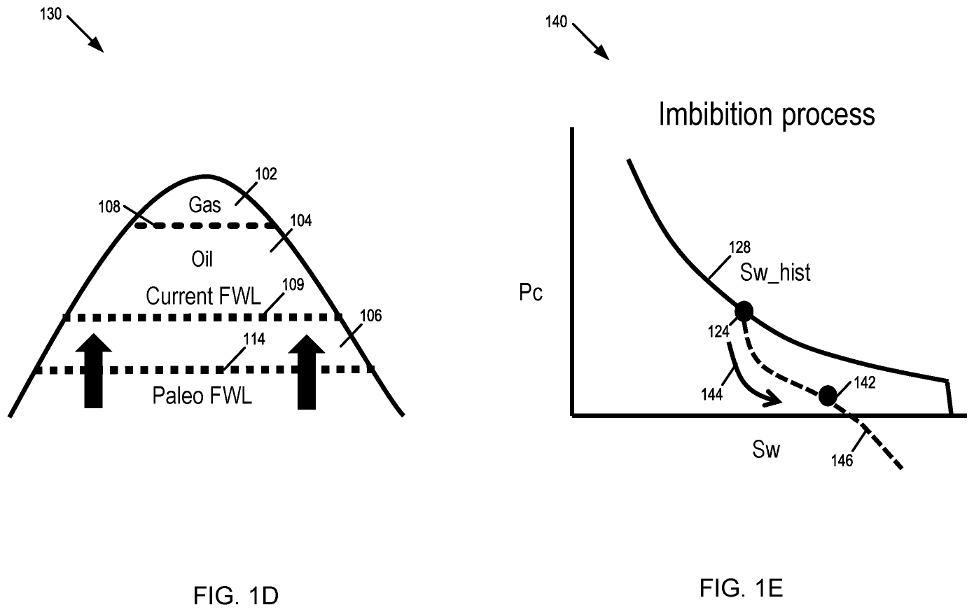

Referring to the figures, FIG. 1A is a representation 100 of a current state of a subsurface and include gas/oil interface 108 (between gas region 102 and oil region 104) and oil/water interface (between oil region 104 and water region 106) in the subsurface. The representation 100 in FIG. 1A may be present in many large oil or gas fields in which well logs indicate a retaining trapped oil or gas zone below the main pay zone as well as the current free water level (FWL), which may be referred to as paleo zone. The formation of the paleo zone may be caused by structural tectonic events with subsequent water influx which could also form tilted water-hydrocarbon contact, as discussed in the background.

In one or some embodiments, the methodology is configured to generate a paleo contact initialization consistent (interchangeably termed an initialization model) with one or both of the following: (i) the available data (e.g., one or both of the saturation height function (SHF) or the well log data); and (ii) the physics embodied in generating the reservoir in the subsurface (e.g., one or both of hysteresis or gravity equilibrium). In particular, the methodology may model paleo zone fluids and the associated pressure distribution to realistically capture the underlying physics during the reservoir charging and contact movement resulting in the formation of paleo zone. In turn, the paleo contact initialization may be used for reservoir simulation, such as an initial model for both oil and gas reservoir simulation models.

In order to accomplish both (i) and (ii), the methodology comprises an initialization method that accounts for the free water level (FWL) migration from Paleo-contact to the current state and for the underlying physics of the FWL migration, such as illustrated in FIGS. 1B-E. Specifically, FIG. 1B is a first representation 110 of a paleo-contact (see Paleo FWL 114) where the presence of oil/gas is below the current FWL 109 (illustrated in FIG. 1D). Correspondingly, FIG. 1C is a graph 120 of water saturation (Sw) versus capillary pressure (Pc) showing the path 126 along a first curve 128 from point 122 to point 124 as part of the drainage process (e.g., the process in which the reservoir is being created) corresponding to the movement of the paleo-contact depicted in FIG. 1B. FIG. 1C illustrates point Sw_hist, which is considered the fully charged point.

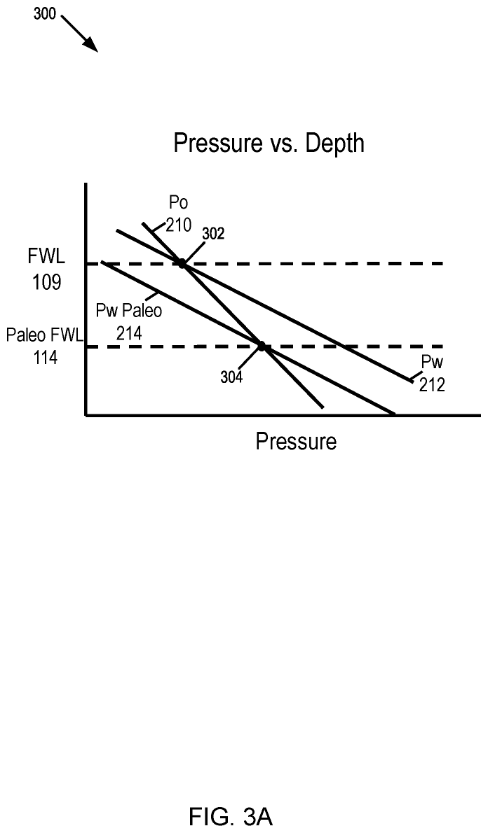

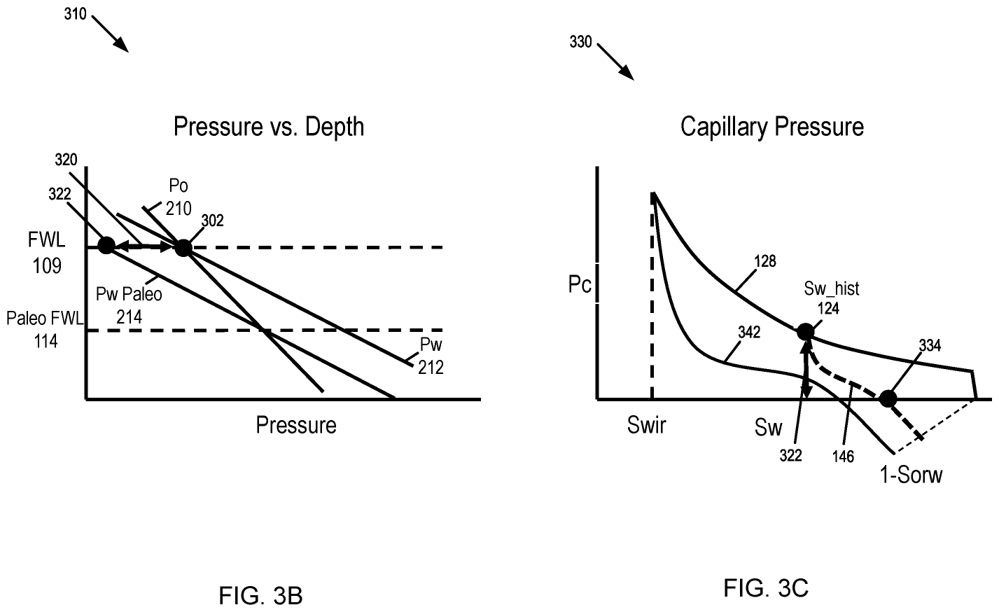

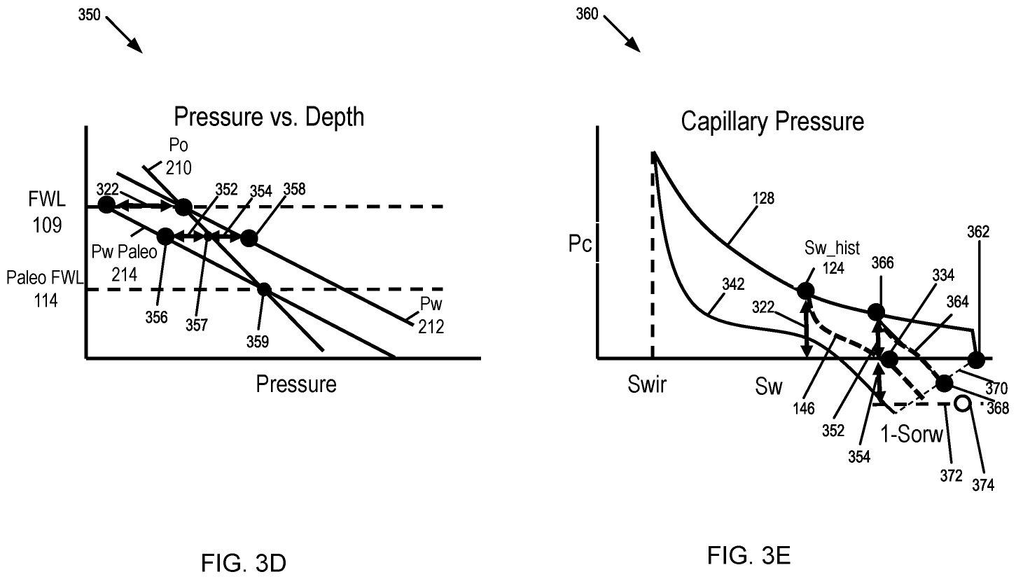

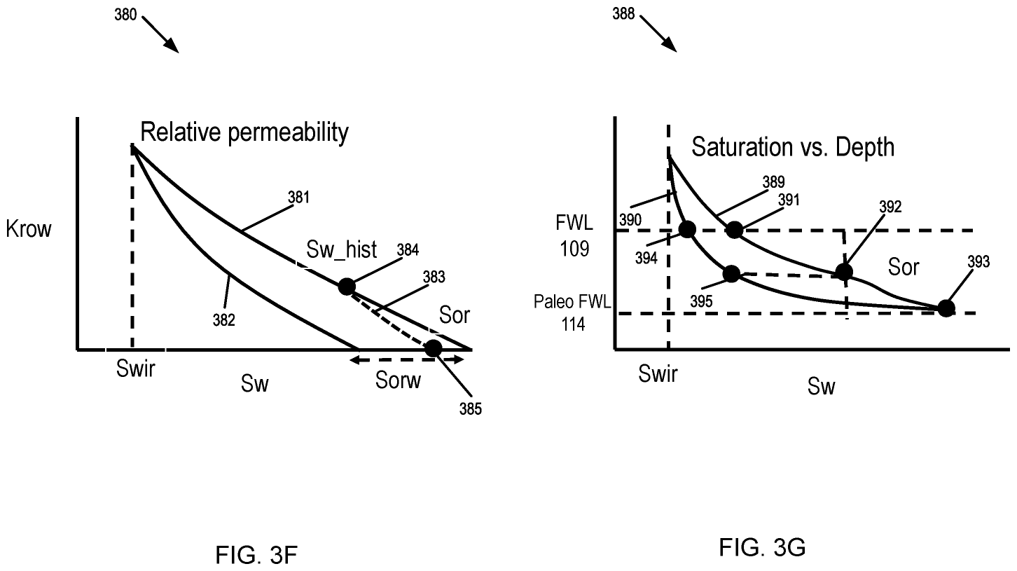

FIG. 1D is a representation 130 of the movement of the various interfaces, including from the paleo FWL 114 to the current FWL 109. FIG. 1E is a graph 140 of water saturation (Sw) versus capillary pressure (Pc) showing the path 144 along a second curve 146 (termed a scanning curve) from point 124 to point 142 as part of the imbibition process corresponding to the movement from the paleo FWL 114 approaching to the current FWL 109 depicted in FIG. 1D. As discussed in more detail below with regard to FIG. 3D, curve 146 is in between the drainage curve 128 and the imbibition curve.

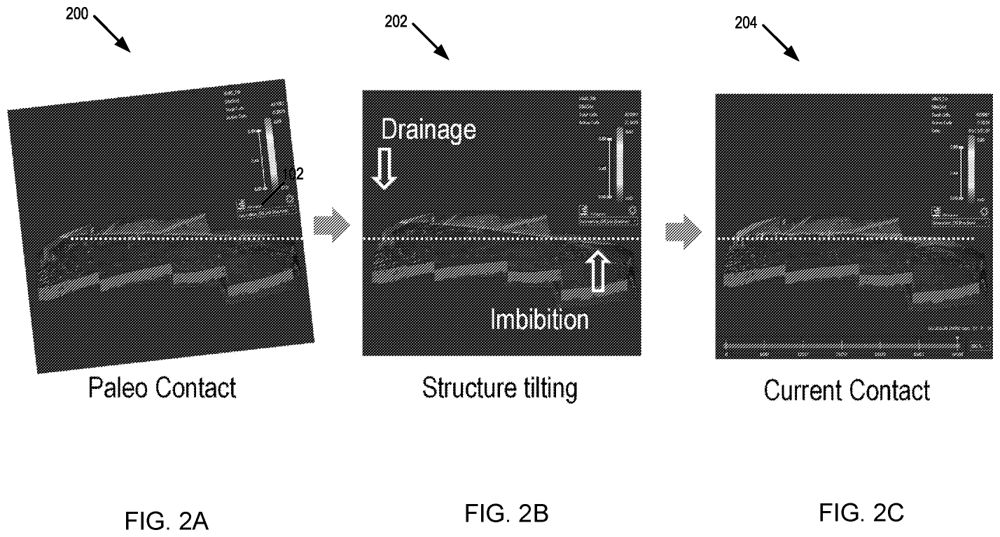

FIGS. 2A-C are a series of images 200, 202, 204 illustrating the various stages, from paleo contact (FIG. 2A) to structure tilting (FIG. 2B) to current contact (FIG. 2C), whereby the structure tilting results in water migration inducing fluid rebalancing which may result in trapped oil below the current FWL (as depicted in FIG. 2C).

As discussed above, various input data are available including any one, any combination, or all of: oil pressure at a reference depth; depth of the FWL; fluid density; and depth of the Paleo FWL. These various inputs may be used to generate a plot, such as illustrated in FIG. 3A, which is a graph 300 of pressure versus depth with a curve 212 (shown as a straight line) for the current water pressure (Pw), a curve 210 for current oil pressure (Po) and a curve 214 for Paleo water pressure (Pw Paleo). Point 302 is where curve 212 for Pw and curve 210 for Po intersect and where the pressure is equal, further coinciding with the current FWL 109, with various input data, such as the oil pressure at the reference depth, the depth of the FWL, and the fluid density, being used to generate curves 210, 212. For example, pressure may be measured at one or more reference depths. Responsive to determining the pressure depth, fluid density may be determined. Using a force balance of the pressure and gravity (which is driven by the fluid density), the curve 210 of distribution of the oil pressure (Po) may be determined. Similarly, point 304 is where curve 214 for Pw Paleo and curve 210 for Po intersect and where the pressure is equal, further coinciding with the paleo FWL 114 (with depth of the Paleo FWL being used to determine curve 214). In one or some embodiments, the slope of curve 214 of Pw Paleo is identical (or nearly identical) to the slope of curve 212 of Pw, but shifted to intersect with the curve 210 of Po at the Paleo FWL 114.

FIG. 3B is the graph 310 depicted in FIG. 3A with the highlighted distance between the different curves as a difference in pressure, measured as 320 between point 302 and point 322. FIG. 3C is a graph 330 of the water saturation (Sw) versus capillary pressure (Pc) with the difference in pressure (measured as 320) from FIG. 3B illustrated. Point 334 is the current water saturation (Sw) at the FWL (e.g., where the capillary pressure Pc=0). FIG. 3C further illustrates drainage curve 128, imbibition curve 342, and scanning curve 146. As discussed above, scanning curve 146 is generally bounded between drainage curve 128 and imbibition curve 342. Further, as discussed below, the methodology may determine one or more points along scanning curve 146 and may iteratively modify curvature of scanning curve 146 in order to better fit the available data.

In particular, in order to determine the points along scanning curve 146, the methodology may obtain the historical minimum saturation for various parts of the subsurface, such as for each column, with equations being represented as follows:

P_{cow}(Paleo)=Pₒ−P_{w}(Paleo)

FIG. 3C illustrates P_{cow}(Paleo) as 322

S_{w_hist}=get_inv_pc(P_{cow}(Paleo))//inverse look up on the drainage curve.

In other words, an inverse lookup of the known capillary pressure Pc results in S_{w_hist}, which in turn may be used to determine at least one point along scanning curve 146 for the imbibition process. In this way, determining P cow (Paleo) and S_{w_hist} may anchor the imbibition process and may assist in the reconstruction of the reservoir saturation distribution.

In turn, the methodology may compute the current saturations by using the corresponding scanning curve (illustrated in FIG. 3C as 146), with the equations being represented as:

P_{cow}(current)=Pₒ−P_{w}(current)

S_{w}=get_inv_current_pc(P_{cow}(current),S_{w_hist})//inverse look up on the scanning curve for each cell.

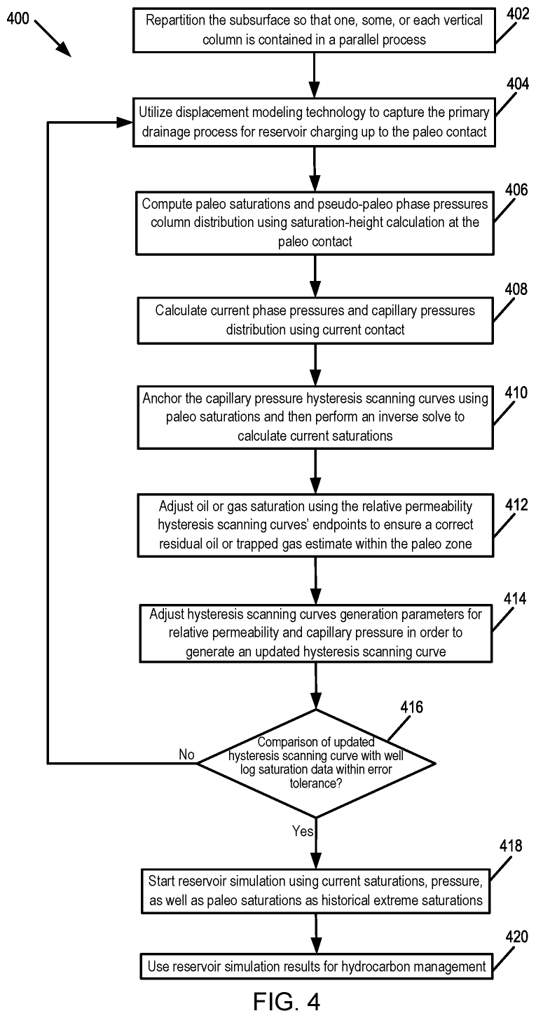

As noted above, two points on scanning curve 146 are known: S_{w_hist}; and the current saturation. Further, the curvature of scanning curve 146 is generally known. However, the precise curvature of scanning curve 146 may be determined iteratively to better match the available data (e.g., reduce error of the proposed scanning curve 146 with the well log data), which is discussed further below with regard to 414 in FIG. 4.

The curvature of curve 146 may be generated in one of several ways. One way is disclosed in US Patent Application Publication No. 2019/0187311 A1, incorporated by reference herein in its entirety (e.g., isomorphic reversible scanning curves). In one or some embodiments, one or more parameters may be modified in order to modify the curvature of curve 146, thereby iteratively better matching the available data.

FIG. 3D is the graph 350 depicted in FIG. 3A with additional highlighted distances between the different curves as additional differences in pressure. FIG. 3E is a graph 360 of the water saturation (Sw) versus capillary pressure (Pc) illustrated in FIG. 3C with the additional differences in pressure from FIG. 3D illustrated. As discussed above, the methodology may determine properties of the subsurface at various depths and at different sections of the subsurface. For example, the subsurface may be partitioned into different sections, such as different vertical columns, with different associated scanning curves. See 402 in FIG. 4. Further, different points in a respective section, such as different points a respective column, may be investigated, such as at the current FWL or at other depths. FIG. 3D illustrates the pressure differences between Po 210 and Pw 212 at a second depth (shown as 354 between point 357 on Po 210 and point 358 on Pw 212) and between Po 210 and Pw Paleo 214 (shown as 352 between point 357 on P0 210 and point 356 on Pw Paleo 214). These distances 352, 354 may be used to generate a second scanning curve 364 at the second depth. See FIG. 3E. It is noted that 322 and 352+354 approximately form a parallelogram so that 322 approximately equals the sum of 352 and 354.

FIG. 3E illustrates multiple scanning curves, such as 146, 364, each of which is anchored at points 124, 366 (both of which are historical saturation/historical capillary pressure points), respectively, on curve 128. In this regard, curves 146, 364 may be considered scanning curves or different elevations.

FIG. 3E further illustrates under the X-axis extensions of curves 146, 364. As shown, line 372 extends horizontally from 354 to point 374, which is the idealized point at which the curve should extend. However, FIG. 3F, which is a graph 380 of water saturation (Sw) versus relative permeability (Know), illustrates the deviation from the ideal. Further, FIGS. 3E-F illustrate Sorw (the residual oil saturation after water flood) and Sor (a residual oil saturation). In particular, curve 381 is the relative permeability of oil for the drainage curve and curve 382 is the relative permeability of oil for the imbibition curve. Further, curve 383 is a scanning curve that deviates from curve 381 at point 384 and intersects at 385, reflecting the reality that once the relative permeability becomes zero, oil cannot flow anymore. In other words, the hydrostatic pressure barrier acts as a mobility barrier preventing flow. This deviation is shown at 368 (formed from line 370 intersecting point 362 and curve 342, and different from the ideal of 374).

FIG. 3G is a graph 388 of water saturation (Sw) versus depth with points highlighted from FIGS. 3D-F. In particular, curve 389 is a current curve, and 390 is a historical curve. Point 391 corresponds to point 334 in FIG. 3E, point 394 corresponds to point 124 in FIG. 3E, point 392 corresponds to point 368 in FIG. 3E, point 393 corresponds to point 362 in FIG. 3E, and point 395 corresponds to point 366 in FIG. 3E.

FIG. 4 is a flow chart 400 for determining the pressure distribution, such as by using parallel computational architectures for each vertical column of grid-blocks of reservoir model. At 402, the subsurface is repartitioned so that one, some, or each vertical column is contained in a parallel process. As discussed above, the subsurface may be partitioned, such as partitioned into vertical columns. Further, due to computational efficiency, one, some or each of the vertical columns may be assigned to a parallel process using high performance computing (HPC).

At 404, the methodology utilizes displacement modeling technology to capture the primary drainage process for reservoir charging up to the paleo contact. As discussed above, the primary drainage curve (e.g., 128 in FIG. 1C) may be used to determine the intersection to locate the historical saturation (e.g., Sw_hist 124 in FIG. 3C). At 406, the methodology computes paleo saturations and pseudo-paleo phase pressures column distribution using saturation-height calculation at the paleo contact. See intersections based on the Paleo FWL and Paleo free oil level in FIG. 3A. At 408, the methodology calculates current phase pressures and capillary pressures distribution using current contact.

At 410, the methodology anchors the capillary pressure hysteresis scanning curves using paleo saturations and then perform an inverse solve to calculate current saturations. See FIG. 3E, including Sw_hist 124 and 334. At 412, the methodology adjusts oil or gas saturation using the relative permeability hysteresis scanning curves' endpoints to ensure a correct residual oil or trapped gas estimate within the paleo zone. This is illustrated, for example, in FIG. 3E.

At 414, the methodology adjusts one or more hysteresis scanning curves generation parameters for relative permeability and capillary pressure in order to generate an updated hysteresis scanning curve. At 416, the methodology compares the updated hysteresis scanning curve with well log saturation data to determine whether within error tolerance. If not, flow chart 400 loops back to 404 in order to perform another iteration of 404 to 416 in order to generate/evaluate the updated hysteresis scanning curve. If so, the methodology determines that the updated hysteresis scanning curve may be used for initializing the reservoir simulation. Specifically, at 418, the methodology starts the reservoir simulation using current saturations, pressure, as well as paleo saturations as historical extreme saturations. At 420, the methodology may then use the results of the reservoir simulation for hydrocarbon management. As discussed above, the reservoir simulation may be used in various stages of hydrocarbon management, such as in any one, any combination, or all of: hydrocarbon extraction; hydrocarbon production; hydrocarbon exploration; identifying potential hydrocarbon-bearing formations; characterizing hydrocarbon-bearing formations; identifying well locations; etc.

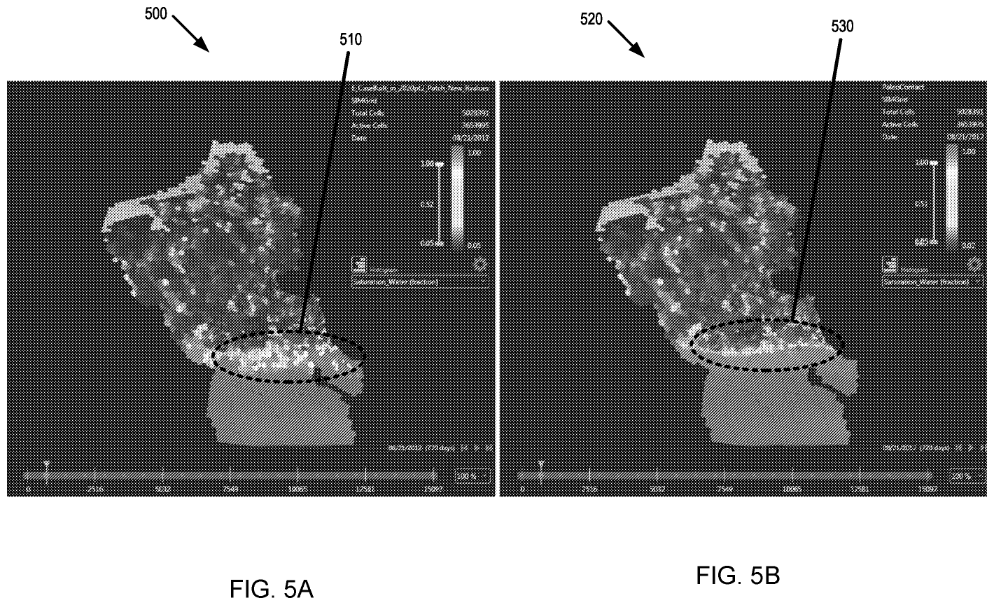

FIG. 5A is an image 500 illustrating an initialization of the water front movement using a typical methodology. FIG. 5B is an image 520 illustrating an initialization of the water front movement using the disclosed methodology, with more stable waterfront movement shown in FIG. versus 5A, as illustrated by highlighted areas 510, 530.

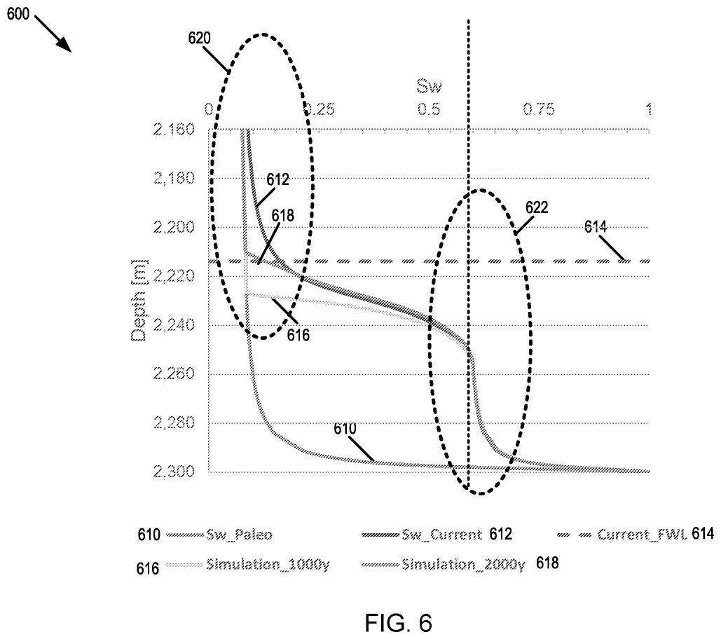

FIG. 6 is a graph 600 of water saturation (Sw) versus depth for simulation results (e.g., g5 simulation) and for initialization using the disclosed methodology. Specifically, different methodologies, including Sw_Paleo, Sw_Current, Simulation_1000y, Simulation_2000y correspond to curves 610, 612, 616, 618. The current FWL is also shown at 614. As shown, the disclosed methodology, illustrated as Sw_Current 612 tracks the g5 simulations of 1000 years (616) and of 2000 years (618), including at highlighted areas 620, 622.

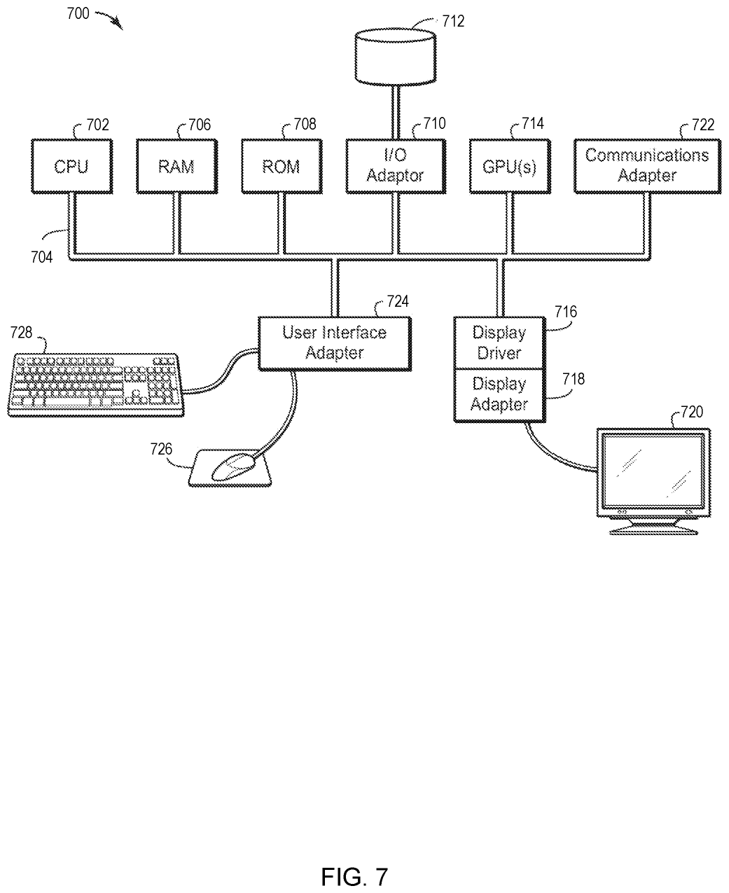

In all practical applications, the present technological advancement must be used in conjunction with a computer, programmed in accordance with the disclosures herein. For example, FIG. 7 is a diagram of an exemplary computer system 700 that may be utilized to implement methods described herein. A central processing unit (CPU) 702 is coupled to system bus 704. The CPU 702 may be any general-purpose CPU, although other types of architectures of CPU 702 (or other components of exemplary computer system 700) may be used as long as CPU 702 (and other components of computer system 700) supports the operations as described herein. Those of ordinary skill in the art will appreciate that, while only a single CPU 702 is shown in FIG. 7, additional CPUs may be present. Moreover, the computer system 700 may comprise a networked, multi-processor computer system that may include a hybrid parallel CPU/GPU system. The CPU 702 may execute the various logical instructions according to various teachings disclosed herein. For example, the CPU 702 may execute machine-level instructions for performing processing according to the operational flow described.

The computer system 700 may also include computer components such as non-transitory, computer-readable media. Examples of computer-readable media include computer-readable non-transitory storage media, such as a random-access memory (RAM) 706, which may be SRAM, DRAM, SDRAM, or the like. The computer system 700 may also include additional non-transitory, computer-readable storage media such as a read-only memory (ROM) 708, which may be PROM, EPROM, EEPROM, or the like. RAM 706 and ROM 708 hold user and system data and programs, as is known in the art. The computer system 700 may also include an input/output (I/O) adapter 710, a graphics processing unit (GPU) 714, a communications adapter 722, a user interface adapter 724, a display driver 716, and a display adapter 718.

The I/O adapter 710 may connect additional non-transitory, computer-readable media such as storage device(s) 712, including, for example, a hard drive, a compact disc (CD) drive, a floppy disk drive, a tape drive, and the like to computer system 700. The storage device(s) may be used when RAM 706 is insufficient for the memory requirements associated with storing data for operations of the present techniques. The data storage of the computer system 700 may be used for storing information and/or other data used or generated as disclosed herein. For example, storage device(s) 712 may be used to store configuration information or additional plug-ins in accordance with the present techniques. Further, user interface adapter 724 couples user input devices, such as a keyboard 728, a pointing device 726 and/or output devices to the computer system 700. The display adapter 718 is driven by the CPU 702 to control the display on a display device 720 to, for example, present information to the user such as subsurface images generated according to methods described herein.

The architecture of computer system 700 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system 700 may include various plug-ins and library files. Input data may additionally include configuration information.

Preferably, the computer is a high-performance computer (HPC), known to those skilled in the art. Such high-performance computers typically involve clusters of nodes, each node having multiple CPU's and computer memory that allow parallel computation. The models may be visualized and edited using any interactive visualization programs and associated hardware, such as monitors and projectors. The architecture of system may vary and may be composed of any number of suitable hardware structures capable of executing logical operations and displaying the output according to the present technological advancement. Those of ordinary skill in the art are aware of suitable supercomputers available from Cray or IBM or other cloud computing based vendors such as Microsoft. Amazon.

The above-described techniques, and/or systems implementing such techniques, can further include hydrocarbon management based at least in part upon the above techniques, including using the device in one or more aspects of hydrocarbon management. For instance, methods according to various embodiments may include managing hydrocarbons based at least in part upon the device and data representations constructed according to the above-described methods. In particular, such methods may use the device to evaluate various welds in the context of drilling a well.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

The following example embodiments of the invention are also disclosed.

Embodiment 1: A computer-implemented method of determining and using current steady-state pressure distribution in a subsurface, the method comprising:
determining paleo phase pressure distribution for at least a part of the subsurface;
accessing current phase pressures for the at least a part of the subsurface;
determining, by iteratively determining hysteresis scanning curves using the paleo phase pressure distribution and the current phase pressures, the current steady-state pressure distribution in the at least a part of the subsurface; and
using the current steady-state pressure distribution for hydrocarbon management.

Embodiment 2: The method of embodiment 1:
further comprising partitioning the subsurface into a plurality of vertical columns; and
wherein for each of the plurality of vertical columns, a respective parallel computing processes are performed to iteratively determine the hysteresis scanning curves for a respective vertical column of the subsurface.

Embodiment 3: The method of embodiments 1 and 2:
wherein determining the paleo phase pressure distribution for the at least a part of the subsurface utilizes displacement modeling technology to capture a primary drainage process for reservoir charging up to a paleo contact.

Embodiment 4: The method of embodiments 1-3:
wherein determining the paleo phase pressure distribution for the at least a part of the subsurface further comprises computing paleo saturations and pseudo-paleo phase pressure column distribution using a saturation-height calculation at the paleo contact.

Embodiment 5: The method of embodiments 1-4:
wherein the current phase pressures and capillary pressures distribution are calculated using a current contact.

Embodiment 6: The method of embodiments 1-5:
wherein iteratively determining hysteresis scanning curves using the paleo phase pressure distribution and the current phase pressures comprises:
anchoring the hysteresis scanning curves using paleo saturations;
performing an inverse solve of the hysteresis scanning curves to determine current saturations;
comparing the determined current saturations with measured saturations; and
determining, based on the comparison of the determined current saturations with the measured saturations, whether to continue iteratively determining hysteresis scanning curves.

Embodiment 7: The method of embodiments 1-6:
wherein iteratively determining hysteresis scanning curves further comprises:
adjusting oil or gas saturation using endpoints of a respective hysteresis scanning curve in order to correct a residual hydrocarbon estimate within a paleo zone in the subsurface.

Embodiment 8: The method of embodiments 1-7:
wherein adjusting of the oil or the gas saturation using the endpoints accounts for trapped gas or residual oil saturation in the subsurface.

Embodiment 9: The method of embodiments 1-8:
wherein determining the current steady-state pressure distribution in the at least a part of the subsurface comprises determining one or both of a current steady-state oil/water interface or a current steady-state gas/water interface in the subsurface.

Embodiment 10: The method of embodiments 1-9:
wherein determining the current steady-state pressure distribution in the at least a part of the subsurface comprises determining both a current steady-state oil/water interface and a current steady-state gas/water interface in the subsurface.

Embodiment 11: The method of embodiments 1-10:
wherein using the current steady-state pressure distribution for hydrocarbon management comprises:
using the current steady-state pressure distribution for initializing a subsurface reservoir simulation to generate one or more results; and
using the one or more results for the hydrocarbon management.

Embodiment 12: The method of embodiments 1-11:
wherein the scanning curves are bounded by drainage and imbibition curves.

Embodiment 13: The method of embodiments 1-12:
wherein iteratively determining hysteresis scanning curves using the paleo phase pressure distribution and the current phase pressures comprises:
generating the hysteresis scanning curves by deviating from an ideal scanning curve.

Embodiment 14: The method of embodiments 1-13:
wherein generating the hysteresis scanning curves by deviating from the ideal scanning curve comprises at least partly considering a hydrostatic pressure barrier that acts as a mobility barrier preventing flow.

Embodiment 15: The method of embodiments 1-14:
wherein iteratively determining hysteresis scanning curves comprises determining the hysteresis scanning curves at multiple levels in the subsurface.

Embodiment 16: A system comprising:
a processor; and
a non-transitory machine-readable medium comprising instructions that, when executed by the processor, cause a computing system to perform a method according to any of embodiments 1-15.

Embodiment 17: A non-transitory machine-readable medium comprising instructions that, when executed by a processor, cause a computing system to perform a method according to any of embodiments 1-15.

Embodiment 18: A computer-implemented method to generate a subsurface initialization model for a subsurface, the method comprising:
accessing a current free water level (FWL) indicative of a contact surface between oil and water in the subsurface;
accessing a paleo FWL;
determining a current steady-state oil/water interface and a current steady-state gas/water interface in the subsurface;
performing, using the current steady-state oil/water interface and the current steady-state gas/water interface, a subsurface reservoir simulation to generate one or more results; and
using the one or more results for hydrocarbon management.

Embodiment 19: The method of embodiment 18:
wherein determining the current steady-state oil/water interface and the current steady-state gas/water interface in the subsurface comprises iteratively determining hysteresis scanning curves using paleo phase pressure distribution and current phase pressures in order to determine current steady-state pressure distributions in the subsurface.

Embodiment 20: The method of embodiments 18-19:
wherein the hysteresis scanning curves are bounded by drainage and imbibition curves.

Embodiment 21: The method of embodiments 18-20:
further comprising partitioning the subsurface into a plurality of vertical columns; and
wherein for each of the plurality of vertical columns, a respective parallel computing processes are performed to iteratively determine the hysteresis scanning curves for a respective vertical column of the subsurface.

Embodiment 22: The method of embodiments 18-21:
wherein for each of the plurality of vertical columns:
determining a historical minimum saturation; and
determining a current saturation by using a corresponding scanning curve.

Embodiment 23: A system comprising:
a processor; and
a non-transitory machine-readable medium comprising instructions that, when executed by the processor, cause a computing system to perform a method according to any of embodiments 18-22.

Embodiment 24: A non-transitory machine-readable medium comprising instructions that, when executed by a processor, cause a computing system to perform a method according to any of embodiments 18-22.

### REFERENCES

The following references are hereby incorporated by reference herein in their entirety:
Ahmed Aleidan et al., Residual-Oil Zone: Paleo-Oil Characterization and Fundamental Analysis, SPE Reservoir Evaluation & Engineering, 02: Vol. 20 (2016).
Mohamed Mehdi El Faidouzi et al., Physics-Based Initialization Captures Post-Migration Structural Deformation in Mixed-Wet Carbonates: An Integrated Workflow for Tilted Oil-Water Contact Reservoirs, Abu Dhabi International Petroleum Exhibition and Conference.—Abu Dhabi: SPE, 2020.—Vols. Day 2 Tue, Nov. 10, 2020.
Arne Skauge et al., Gas Injection in Paleo Oil Zones, SPE Annual Technical Conference and Exhibition, Dallas, Texas (2000).
Ian Taggart, Characterisation and Simulation Insights for Gas Reservoirs with Paleo-Contact, SPE Europec featured at EAGE Conference and Exhibition, SPE, 2019.—Vols. Day 2, Jun. 4, 2019.
Leonardo Patacchini et al., Novel Method for Consistent Initialization of Reservoir Simulation Models with Oil/Water Paleo-Contacts, Abu Dhabi International Petroleum Exhibition and Conference.—Abu Dhabi: SPE, 2017.—Vols. Day 3 Wed, Nov. 13, 2017, ISBN: 978-1-61399-563-1.

What is claimed is:

1. A computer-implemented method of determining and using current steady-state pressure distribution in a subsurface, the method comprising:
determining paleo phase pressure distribution for at least a part of the subsurface;
accessing current phase pressures for the at least a part of the subsurface;
determining, by iteratively determining hysteresis scanning curves using the paleo phase pressure distribution and the current phase pressures, the current steady-state pressure distribution in the at least a part of the subsurface; and
using the current steady-state pressure distribution for hydrocarbon management.

2. The method of claim 1, further comprising partitioning the subsurface into a plurality of vertical columns; and
wherein for each of the plurality of vertical columns, a respective parallel computing processes are performed to iteratively determine the hysteresis scanning curves for a respective vertical column of the subsurface.

3. The method of claim 1, wherein determining the paleo phase pressure distribution for the at least a part of the subsurface utilizes displacement modeling technology to capture a primary drainage process for reservoir charging up to a paleo contact.

4. The method of claim 3, wherein determining the paleo phase pressure distribution for the at least a part of the subsurface further comprises computing paleo saturations and pseudo-paleo phase pressure column distribution using a saturation-height calculation at the paleo contact.

5. The method of claim 1, wherein the current phase pressures and capillary pressures distribution are calculated using a current contact.

6. The method of claim 5, wherein iteratively determining hysteresis scanning curves using the paleo phase pressure distribution and the current phase pressures comprises:
anchoring the hysteresis scanning curves using paleo saturations;
performing an inverse solve of the hysteresis scanning curves to determine current saturations;
comparing the determined current saturations with measured saturations; and
determining, based on the comparison of the determined current saturations with the measured saturations, whether to continue iteratively determining hysteresis scanning curves.

7. The method of claim 6, wherein iteratively determining hysteresis scanning curves further comprises:
adjusting oil or gas saturation using endpoints of a respective hysteresis scanning curve in order to correct a residual hydrocarbon estimate within a paleo zone in the subsurface.

8. The method of claim 7, wherein adjusting of the oil or the gas saturation using the endpoints accounts for trapped gas or residual oil saturation in the subsurface.

9. The method of claim 1, wherein determining the current steady-state pressure distribution in the at least a part of the subsurface comprises determining one or both of a current steady-state oil/water interface or a current steady-state gas/water interface in the subsurface.

10. The method of claim 1, wherein determining the current steady-state pressure distribution in the at least a part of the subsurface comprises determining both a current steady-state oil/water interface and a current steady-state gas/water interface in the subsurface.

11. The method of claim 1, wherein using the current steady-state pressure distribution for hydrocarbon management comprises:
using the current steady-state pressure distribution for initializing a subsurface reservoir simulation to generate one or more results; and
using the one or more results for the hydrocarbon management.

12. The method of claim 1, wherein the hysteresis scanning curves are bounded by drainage and imbibition curves.

13. The method of claim 1, wherein iteratively determining hysteresis scanning curves using the paleo phase pressure distribution and the current phase pressures comprises:
generating the hysteresis scanning curves by deviating from an ideal scanning curve.

14. The method of claim 13, wherein generating the hysteresis scanning curves by deviating from the ideal scanning curve comprises at least partly considering a hydrostatic pressure barrier that acts as a mobility barrier preventing flow.

15. The method of claim 1, wherein iteratively determining hysteresis scanning curves comprises determining the hysteresis scanning curves at multiple levels in the subsurface.

16. A computer-implemented method to generate a subsurface initialization model for a subsurface, the method comprising:
accessing a current free water level (FWL) indicative of a contact surface between oil and water in the subsurface;
accessing a paleo FWL;
determining a current steady-state oil/water interface and a current steady-state gas/water interface in the subsurface;
performing, using the current steady-state oil/water interface and the current steady-state gas/water interface, a subsurface reservoir simulation to generate one or more results; and
using the one or more results for hydrocarbon management.

17. The method of claim 16, wherein determining the current steady-state oil/water interface and the current steady-state gas/water interface in the subsurface comprises iteratively determining hysteresis scanning curves using paleo phase pressure distribution and current phase pressures in order to determine current steady-state pressure distributions in the subsurface.

18. The method of claim 17, wherein the hysteresis scanning curves are bounded by drainage and imbibition curves.

19. The method of claim 18, further comprising partitioning the subsurface into a plurality of vertical columns; and
wherein for each of the plurality of vertical columns, a respective parallel computing processes are performed to iteratively determine the hysteresis scanning curves for a respective vertical column of the subsurface.

20. The method of claim 19, wherein for each of the plurality of vertical columns:
determining a historical minimum saturation; and
determining a current saturation by using a corresponding scanning curve.
